(19) United States
(12) Patent Application Publication
(10) Pub. No.: US 2020/0307034 A1
(43) Pub. Date: Oct. 1, 2020

(54) CLEANING SYSTEM AND METHOD FOR USE IN DISLODGING PARTICLES FROM A FILTER

(71) Applicant: Honda Motor Co., Ltd., Tokyo (JP)

(72) Inventors: Gavin Richards, Everett (CA); Jean Nicol, Alliston (CA); David Gangl, Ontario (CA); Douglas F. Grantmyre, Angus (CA); Andy Stewart, Combermere (CA)

(21) Appl. No.: 16/364,361

(22) Filed: Mar. 26, 2019

(51) Int. Cl. B29C 33/72; A47L 9/20; B29B 13/10

(52) U.S. Cl. CPC B29C 33/72; B29C 45/03; B29B 13/10; A47L 9/20

(57) ABSTRACT

A cleaning system for use with a filter is described herein. The cleaning system includes a housing including a main enclosure defining an interior sized to receive the filter, a collection vessel coupled in communication with the housing, and a nozzle configured to direct a stream of air towards the filter to dislodge particles from the filter. A pneumatic suction device is coupled in communication with the collection vessel, wherein the pneumatic suction device is configured to draw the particles dislodged from the filter towards the collection vessel.

### BACKGROUND

The present disclosure relates generally to manufacturing processes and, more specifically, to systems and methods of cleaning a filter that collects material produced from the manufacturing process.

Injection molding is a process wherein molten plastic resin is injected into a mold to allow the resin to form a solid object in the shape of the mold as the resin is cooled. In at least some known injection molding processes, the plastic resin is stored in a silo before it's channeled through a series of ducts and into the injection molding machinery. However, transferring the plastic resin from one location to another within the facility may generate resin dust particles as larger plastic resin particles are tumbled through the ducts. As such, at least some known facilities position a filter within the ductwork to collect the dust particles. Such filters must be periodically cleaned to prevent the filter from clogging. During cleaning however, dust particles may undesirably become built up within the facility over time. The dust particles may pose a safety hazard under certain conditions.

### BRIEF DESCRIPTION

In one aspect, a cleaning system for use with a filter is provided. The cleaning system includes a housing including a main enclosure defining an interior therein sized to receive the filter, a collection vessel coupled in communication with the housing, and a nozzle configured to direct a stream of air towards the filter to dislodge particles from the filter. A pneumatic suction device is coupled in communication with the collection vessel, wherein the pneumatic suction device is configured to draw the particles dislodged from the filter towards the collection vessel.

In another aspect, a method of cleaning a filter is provided. The method includes positioning a filter within an interior of a main enclosure of a housing, sealing the housing, directing a stream of air towards the filter to dislodge particles from the filter, and drawing, with a pneumatic suction device, the particles dislodged from the filter towards a collection vessel.

In yet another aspect, a plastics processing facility is provided. The facility includes a storage vessel configured to store plastic resin therein, an injection molding system, and a piping system configured to couple the storage vessel in flow communication with the injection molding system. The piping system includes a filter configured to collect particles generated by the plastic resin channeled through the piping system. The system also includes a cleaning system configured to receive the filter, and configured to dislodge the particles collected on the filter, wherein the cleaning system is isolated from ignition sources.

### BRIEF DESCRIPTION OF THE DRAWINGS

FIG. 1 is a block diagram of an exemplary plastics processing facility.

FIG. 2 is a front view of an exemplary cleaning system shown in FIG. 1.

FIG. 3 is an internal view of a portion of the cleaning system shown in FIG. 2.

### DETAILED DESCRIPTION

The embodiments described herein relate generally to systems and methods of cleaning a filter that collects material produced from a plastics manufacturing process. The material may be explosible, combustible, or the like. The systems described herein include a housing that receives the filter, a collection vessel coupled in flow communication with the housing, a nozzle that dislodges particles of material from the filter with a stream of air, and a suction device that draws the dislodged particles towards the collection vessel. In one embodiment, the system also includes a vibrating mechanism coupled to the housing to facilitate dislodging particles accumulated on side walls of the housing. In each embodiment, the system is isolated from an ignition source. For example, the housing is sealed to facilitate restricting dislodged particles from being discharged into the surrounding environment. Moreover, the devices and mechanisms included in the cleaning system are not electrically-powered. Rather, in the exemplary embodiments, the devices and mechanisms are pneumatically-powered, for example, such that the risk of inadvertently igniting the material is reduced. As such, the systems and methods described herein enable a filter to be cleaned safely, thereby facilitating increasing the filter's useful service life, reducing operating costs, and improving breathability and cleanliness within an associated processing facility.

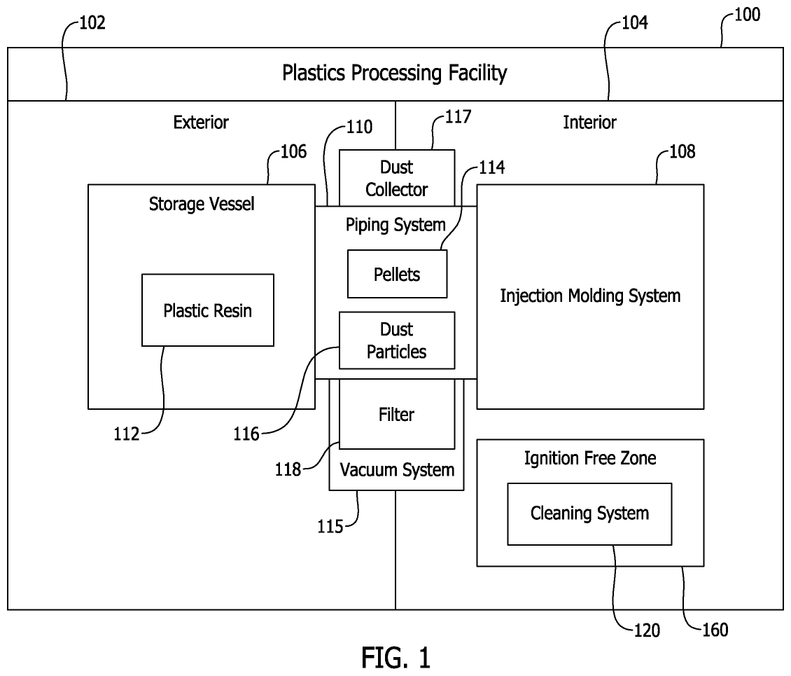

FIG. 1 is a block diagram of an exemplary plastics processing facility 100. In the exemplary embodiment, plastics processing facility 100 facilitates the fabrication of injection molded plastic parts (not shown), and includes an exterior 102 and an interior 104. A storage vessel 106 is located exterior 102 to plastics processing facility 100, while an injection molding system 108 is positioned within interior 104 of plastics processing facility 100. A piping system 110 couples storage vessel 106 in flow communication with injection molding system 108.

In one embodiment, storage vessel 106 stores a quantity of plastic resin 112 therein. Plastic resin 112 may include any polymeric material that enables plastics processing facility 100 to function as described herein. Plastic resin 112 may also be any other material or in any form that enables plastic resin 112 to be channeled from storage vessel 106 towards injection molding system 108. For example, in one embodiment, plastic resin 112 is stored in pelletized form within storage vessel 106, wherein pellets 114 may have a grain size greater than about 1.0 millimeters (mm). Plastic resin 112 within injection molding system 108 is melted and extruded to enable fabrication of an injection molded plastic part.

As described above, plastic resin 112 is channeled through piping system 110 from storage vessel 106 towards injection molding system 108. In some embodiments, dust particles 116 are generated during the transfer process. For example, dust particles 116 may be generated as a result of collisions between individual pellets 114 during transfer, or as a result of collisions between pellets 114 and piping system 110. In at least some embodiments, a vacuum system 115 draws plastic resin 112 from storage vessel 106 through piping system 110 and to injection molding system 108. Vacuum system 115 includes a filter 118 configured to prevent dust particles 116 and/or other debris from adversely effecting operation of vacuum system 115. Alternatively, or in combination with the vacuum system 115 plastics processing facility 100 may also include a separate dust collector 117, that also includes a filter, for example, filter 118, configured to collect dust particles 116, thereby preventing dust particles 116 from dispersing elsewhere within interior 104.

In the exemplary embodiment, a filter 118 is selectively coupled in flow communication with piping system 110, vacuum system 115, and/or dust collector 117. Filter 118 facilitates collecting dust particles 116 channeled through piping system 110, and is selectively isolated from and/or removable from piping system 110 to enable filter 118 to be periodically cleaned. For example, in the exemplary embodiment, plastics processing facility 100 includes a cleaning system 120 for use in dislodging dust particles 116 collected on filter 118.

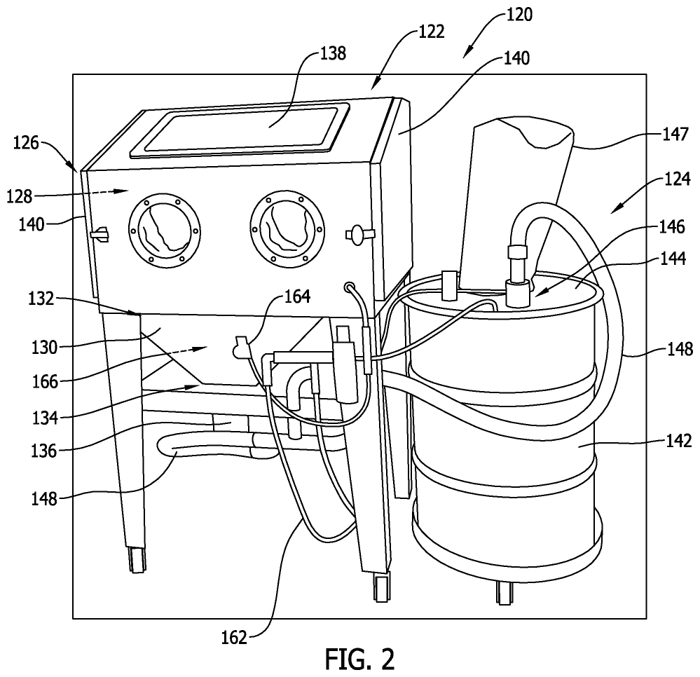

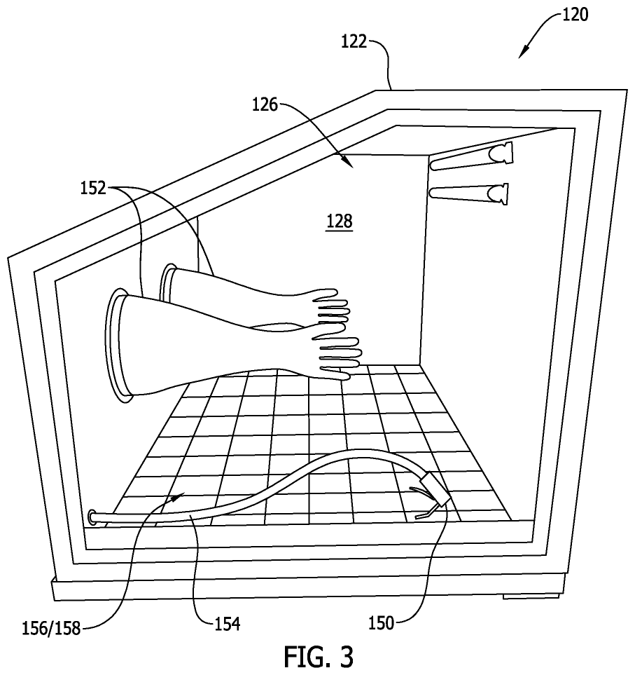

FIG. 2 is a front view of an exemplary cleaning system 120, and FIG. 3 is an internal view of cleaning system 120. In the exemplary embodiment, cleaning system 120 includes a housing 122 and a collection vessel 124 coupled in flow communication with housing 122. Housing 122 includes a main enclosure 126 having an interior 128 sized to receive filter 118 (shown in FIG. 1), and a duct 130 extending from main enclosure 126. In the exemplary embodiment, duct 130 has a first end 132 coupled to main enclosure 126, and a second end 134 separated from first end 132. In the exemplary embodiment, duct 130 progressively decreases in its cross-sectional area from first end 132 to second end 134. As such, a port 136 is formed at second end 134, and dust particles 116 (shown in FIG. 1) dislodged from filter 118 within interior 128 are funneled towards port 136 for discharge towards collection vessel 124.

Housing 122 also includes a transparent window 138 that enables interior 128 to be viewed externally from housing 122. A pair of doors 140 is coupled to housing 122. Doors 140 provide selective access to interior 128, and facilitate sealing interior 128 when closed. As such, housing 122 is sealed when in operation to restrict the release of dust particles 116, dislodged from filter 118, to exterior of housing 122.

In the exemplary embodiment, collection vessel 124 is coupled in flow communication with housing 122. Collection vessel 124 may be any storage container that enables cleaning system 120 to function as described herein. In the exemplary embodiment, collection vessel 124 is a forty five gallon drum having a cylindrical body 142 and a lid 144 coupled to cylindrical body 142. Lid 144 includes an opening 146 defined therein that enables dust particles 116 to be channeled into collection vessel 124. For example, collection vessel 124 is coupled in communication with housing 122 via at least one hose 148 that extends between port 136 and opening 146. In addition, in one embodiment, lid 144 is coupled to cylindrical body 142 with an air tight seal that facilitates restricting the release of dust particles 116 to exterior of collection vessel 124. Collection vessel 124 may also include a collection vessel filter 147.

Referring to FIG. 3, cleaning system 120 includes a nozzle 150 within interior 128, and at least one glove 152 coupled to housing 122. Glove 152 extends into interior 128, and is coupled to housing 122 with an air tight seal. In the exemplary embodiment, glove 152 is fabricated from a rubber material, a latex material, or the like, to facilitate maintaining the air tight seal. Alternatively, glove 152 may be fabricated from any material that enables cleaning system 120 to function as described herein. Nozzle 150 directs a stream of air towards filter 118 (shown in FIG. 1) positioned within interior 128 to facilitate dislodging dust particles 116 (shown in FIG. 1) from filter 118. In the exemplary embodiment, nozzle 150 is coupled to a hose 154 that enables nozzle 150 to be manually articulable within interior 128. In addition, the stream of air discharged from nozzle 150 is at a pressure defined within a range between about 25 and about 30 psig. The pressure may be adjusted by a user of cleaning system 120 with an air regulator. Alternatively, the stream of air may be discharged from nozzle 150 at any pressure that enables cleaning system 120 to function as described herein. As such, in the exemplary embodiment, the potential for damaging filter 118 during performance of a cleaning cycle is reduced.

In the exemplary embodiment, housing 122 includes a grate 156 between main enclosure 126 and duct 130, such that grate 156 defines a bottom wall 158 of main enclosure 126. Grate 156 is perforated to provide communication between main enclosure 126 and duct 130. As such, when cleaning system 120 is in use, an operator (not shown) standing exterior to housing 122 may use glove 152 to manipulate the orientation of and/or use filter 118 within interior 128. Dust particles 116 dislodged from filter 118 by nozzle 150 are drawn through grate 156 by a negative pressure induced downstream from interior 128, as will be described in more detail below.

In the exemplary embodiment, cleaning system 120 is isolated from ignition sources. For example, referring to FIG. 1, cleaning system 120 is isolated from ignition sources by maintaining an ignition free zone 160 around a source of dust particles 116 (e.g., housing 122 and collection vessel 124) within cleaning system 120. Ignition free zone 160 may be defined by a predetermined distance from the source of dust particles 116, wherein ignition sources are prohibited from being positioned closer to the source of dust particles 116 than the predetermined distance. As such, cleaning system 120 is assembled with components that are incapable of producing and/or becoming an ignition source.

For example, referring again to FIG. 2, cleaning system 120 includes a suction device 162 coupled in communication with collection vessel 124. Suction device 162 draws dust particles 116 (shown in FIG. 1) dislodged from filter 118 towards collection vessel 124 for storage therein. Suction device 162 may be any device that enables cleaning system 120 to function as described herein. For example, as noted above, cleaning system 120 is isolated from an ignition source to reduce the risk of inadvertently igniting dust particles 116. Exemplary ignition sources may include hot surfaces, static electricity, bearings, electrical wiring, and grounding. Thus, in one embodiment, cleaning system 120 is isolated by using any suction device 162 that is energized with any power source that does not purposefully or potentially produce a spark and/or excessive heat. Suitable power sources include, but are not limited to only including, pneumatic power, hydraulic power, and the like. In the exemplary embodiment, suction device 162 is a venturi pump that creates a pressure differential between housing 122 and collection vessel 124 using the venturi effect. As such, dust particles 116 are drawn towards collection vessel 124 in a safe and efficient manner.

Cleaning system 120 also includes a pneumatic vibrator 164 coupled to housing 122. Pneumatic vibrator 164 dislodges dust particles 116 accumulated on an interior surface 166 of housing 122. As such, the collection of dust particles 116 within collection vessel 124 is enhanced. In the exemplary embodiment, pneumatic vibrator 164 is a piston-driven or a ball bearing-driven device, wherein moving parts of pneumatic vibrator 164 are actuated via pneumatic power. Alternatively, vibrator 164 may be actuated with any power source that does not potentially or purposefully produce a spark and/or excessive heat to facilitate isolating cleaning system 120 from potential ignition sources.

The embodiments described herein relate to systems and methods of cleaning a filter in a safe an efficient manner. The systems and methods described herein accomplish the aforementioned objectives by isolating the cleaning systems from ignition sources capable of reacting with dust particles dislodged from the filter, such as by assembling the cleaning system with components that are actuated by a power source other than electricity. As such, the system and methods described herein enable dust particles formed from sensitive material to be cleaned from the filter and handled in accordance with known safety regulations, thereby increasing the filter's useful service life and reducing operating costs of an associated plastics processing facility.

Exemplary embodiments of cleaning systems and related methods are described above in detail. Although the systems herein are described and illustrated in association with a plastics processing facility, the invention is also intended for use with any object that requires periodic cleaning. Moreover, it should also be noted that the components of the invention are not limited to the specific embodiments described herein, but rather, aspects of each component may be utilized independently and separately from other components and methods of assembly described herein.

This written description uses examples to disclose various embodiments, including the best mode, and also to enable any person skilled in the art to practice the various implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A cleaning system for use with a filter, the cleaning system comprising:
a housing comprising a main enclosure defining an interior therein sized to receive the filter;
a collection vessel coupled in communication with the housing;
a nozzle configured to direct a stream of air towards the filter to dislodge particles from the filter; and
a pneumatic suction device coupled in communication with the collection vessel, wherein the pneumatic suction device is configured to draw the particles dislodged from the filter towards the collection vessel.

2. The cleaning system in accordance with claim 1, wherein the cleaning system is isolated from ignition sources.

3. The cleaning system in accordance with claim 1 further comprising a pneumatic vibrator coupled to the housing for dislodging particles accumulated on an interior surface of the housing.

4. The cleaning system in accordance with claim 3, wherein the housing further comprises a duct extending from the main enclosure, wherein the pneumatic vibrator is coupled to the duct.

5. The cleaning system in accordance with claim 4 further comprising a grate between the main enclosure and the duct, wherein the grate defines a bottom wall of the main enclosure.

6. The cleaning system in accordance with claim 1, wherein the housing further comprises a transparent window that provides a view into the interior from exterior of the housing.

7. The cleaning system in accordance with claim 1, wherein the pneumatic suction device comprises a venturi pump.

8. The cleaning system in accordance with claim 1 further comprising a glove coupled to the housing and extending into the interior.

9. The cleaning system in accordance with claim 1 further comprising a hose coupled to the nozzle such that the nozzle is manually articulable within the interior.

10. The cleaning system in accordance with claim 1, wherein the housing is sealed to restrict the release of the particles, dislodged from the filter, exterior of the housing.

11. A method of cleaning a filter, the method comprising:
positioning a filter within an interior of a main enclosure of a housing;
sealing the housing;
directing a stream of air towards the filter to dislodge particles from the filter; and
drawing, with a pneumatic suction device, the particles dislodged from the filter towards a collection vessel.

12. The method in accordance with claim 11 further comprising isolating the housing and the collection vessel from ignition sources.

13. The method in accordance with claim 11, wherein directing a stream of air comprises discharging the stream of air from a nozzle at a pressure less than about 30 psig.

14. The method in accordance with claim 11 further comprising dislodging, with a pneumatic vibrator coupled to the housing, particles accumulated on an interior surface of the housing.

15. The method in accordance with claim 14, wherein the housing further includes a duct coupled between the main enclosure and the collection vessel, wherein dislodging particles comprises dislodging the particles with the pneumatic vibrator coupled to the duct.

16. The method in accordance with claim 11, wherein directing a stream of air comprises manually articulating a nozzle, configured to discharge the stream of air, relative to the filter.

17. A plastics processing facility comprising:
a storage vessel configured to store plastic resin therein;
an injection molding system;
a piping system configured to couple the storage vessel in flow communication with the injection molding system, wherein the piping system comprises a filter configured to collect particles generated by the plastic resin channeled through the piping system; and
a cleaning system configured to receive the filter, and configured to dislodge the particles collected on the filter, wherein the cleaning system is isolated from ignition sources.

18. The plastics processing facility in accordance with claim 17, wherein the cleaning system comprises:
a housing comprising a main enclosure defining an interior therein sized to receive the filter;
a collection vessel coupled in communication with the housing;
a nozzle configured to direct a stream of air towards the filter to dislodge the particles from the filter; and
a pneumatic suction device coupled in communication with the collection vessel, wherein the pneumatic suction device is configured to draw the particles dislodged from the filter towards the collection vessel.

19. The plastics processing facility in accordance with claim 18, wherein the cleaning system further comprises a pneumatic vibrator coupled to the housing, wherein the pneumatic vibrator is configured to dislodge particles accumulated on an interior surface of the housing.

20. The plastics processing facility in accordance with claim 18, wherein the pneumatic suction device comprises a venturi pump.
